(19) United States
(12) Patent Application Publication
(10) Pub. No.: US 2002/0184651 A1
(43) Pub. Date: Dec. 5, 2002

(54) Data processing apparatus, information managing method, computer program product for data processing apparatus, and data processing network system

(76) Inventor: Ken Matsushita, Fukaya-shi (JP)

Correspondence Address: PILLSBURY WINTHROP, LLP, P.O. BOX 10500, MCLEAN, VA, 22102, US

(21) Appl. No.: 09/983,327

(22) Filed: Oct. 24, 2001

(30) Foreign Application Priority Data
May 31, 2001 (JP) 2001-165409

(51) Int. Cl. H04N 7/16; H04N 7/173

(52) U.S. Cl. 725/131; 725/139; 725/151

(57) ABSTRACT

There is disclosed a data processing apparatus for preparing recorded program information during recording of the program information into a tape, associating and storing the recorded program information with tape identification information in a storage section, copying the information into a memory, and providing the information to another apparatus on a network. When the tape is set and the identification information is read, the corresponding recorded program information is searched from the storage section. If the information is not found, the provided information of another apparatus is searched via the network. A search result is sent to a display, and the recorded program information of the set tape is subjected to navigation display.

### CROSS-REFERENCE TO RELATED APPLICATIONS

This application is based upon and claims the benefit of priority from the prior Japanese Patent Application No. 2001-165409, filed May 31, 2001, the entire contents of which are incorporated herein by reference.

### BACKGROUND OF THE INVENTION

1. Field of the Invention

The present invention relates to a data processing apparatus for a network, for example to a technique suitable for an audio video apparatus in which a network of IEEE 1394 standards is utilized.

2. Description of the Related Art

In conventional data recording/reproducing apparatuses such as a video tape recorder (VTR), there is sometimes provided a navigation function for informing a user of a portion of a recording medium in which information is recorded, and a content of the information. For the navigation function, during recording of a program into a removable medium, recording management information (channel, start time, end time, and the like) for managing a content of the recorded program, and identification information of the removable medium are stored in storage apparatuses such as a nonvolatile memory disposed in a recording apparatus itself. Moreover, when the removable medium is inserted, the medium is identified and corresponding information attached to the recorded program is searched and displayed from the information stored in the storage apparatus of the recording apparatus itself. Examples of the function include a tape navigation function described in Japanese Patent No. 3096938 (Hitachi, Ltd.).

In another example, a label including a non-contact memory in which the information attached to the recorded program is written is attached to the removable medium with the program recorded therein, so that the similar navigation function is performed. Additionally, in this example, even when any recording/reproducing apparatus having a non-contact memory reading function reproduces the information, the navigation function can be realized, but a high cost is disadvantageously required.

As described above, in a data processing apparatus having the conventional navigation function, since the management information for each removable medium is memorized in a memory device disposed in the recording apparatus itself, a different reproducing apparatus cannot refer to the management information. Therefore, the navigation function for a user in which the management information for each removable medium is displayed during reproduction can be executed only when the same apparatus as the apparatus having recorded the information into each removable medium reproduces the information.

### BRIEF SUMMARY OF THE INVENTION

An object of the present invention is to provide a data processing apparatus, information managing method, computer program product for data processing apparatus, and data processing network system in which management information of each removable medium generated during recording of information into the removable medium and identification information of the medium can be obtained from the outside, and thereby the management information can be produced to a user even during setting of the removable medium having the information recorded by another apparatus.

In order to achieve the aforementioned object, according to the present invention there is provided a data processing apparatus which records and reproduces data on and from a removable medium recoding identification information, and has a communication interface communicating with another data processing apparatus via a communication network, the data processing apparatus comprising, a reader which reads the identification information from the removable medium when the removable medium is loaded in the data processing apparatus, a generator which generates management information for managing the data recorded on the removable medium while the data is recorded on the removable medium, a storage which stores the identification information read by the reader and the management information related to the identification information, a searcher which searches the identification information and the management information from the storage, when the identification information is read by the reader, an output device which outputs the identification information and the management information searched by the searcher, and a supplier which supplies the identification information and the management information stored in the storage to another data processing apparatus in response to a request from the another data processing apparatus.

Moreover, according to the present invention there is provided a data processing apparatus having a communication interface, which communicates with another data processing apparatus via a communication network, wherein the another data processing apparatus reads inherent identification information from a removable medium when the removable medium is loaded in the another data processing apparatus, and generates management information for managing data recorded on the removable medium while the data is recorded on the removable medium, and the data processing apparatus comprises, a collector which collects the identification information and the management information provided by the another data processing apparatus on the communication network via the communication interface, and an output device which outputs the information collected by the collector.

Furthermore, according to the present invention, there is provided an information managing method for a first data processing apparatus which records and reproduces data on and from a removable medium recording identification information and communicates with at least one second data processing apparatus via a communication network, the method comprising, reading the identification information from the removable medium when the removable medium is loaded in the first data processing apparatus, generating management information for managing the data recorded on the removable medium while the data is recorded on the removable medium, storing the identification information and the management information related to the identification information into a storage of the first data processing apparatus, performing inside-searching for searching the storage of the first data processing apparatus for the identification information and the management information, when the identification information is read from the removable medium, performing outside-searching for searching the second data processing apparatus for the identification information and the management information, when the identification information and the management information are not detected from the storage, and outputting the identification information and the management information detected in the inside-searching and the outside-searching.

Additionally, according to the present invention, there is provided an information managing method for a first data processing apparatus which records and reproduces data on and from a removable medium recoding identification information and communicates at least one second data processing apparatus via a communication network, the method comprising, reading the identification information when the removable medium is loaded in the first data processing apparatus, generating management information for managing the data recorded in the removable medium while the data is recorded on the removable medium, storing the identification information and the management information related to the identification information into a storage of the first data processing apparatus, performing inside-referring for referring to all the identification information and the management information stored in the storage, performing outside-referring for referring to all the identification information and the management information provided by the second data processing apparatus on the communication network, and outputting respective referring results obtained in the inside-referring and the outside-referring together with the identification information read by the reading.

Moreover, according to the present invention, there is provided a computer program product for operating a computer for managing information of a first data processing apparatus which records and reproduces data on and from a removable medium recording identification information and communicates at least one second data processing apparatus via a communication network, the computer program product comprising, program code for reading the identification information from the removable medium when the removable medium is loaded in the first data processing apparatus, program code for generating management information for managing the data recorded on the removable medium while the data is recorded on the removable medium, program code for storing the identification information and the management information related to the identification information into a storage of the first data processing apparatus, program code for performing inside-searching for searching the storage of the first data processing apparatus for the identification information and the management information, when the identification information is read in the reading, program code for performing outside-searching for searching the second data processing apparatus for the identification information and the management information, when the identification information and the management information are not detected in the inside-searching, and program code for outputting the identification information and the management information detected in the inside searching and the outside searching.

Moreover, according to the present invention, there is provided a computer program product for operating a computer for managing information of a first data processing apparatus which records and reproduces data on and from a removable medium recording identification information and communicates at least one data processing apparatus via a communication network, the computer program product comprising, program code for reading the identification information from the removable medium when the removable medium is loaded in the first data processing apparatus, program code for generating management information for managing the data recorded on the removable medium while the data is recorded on the removable medium, program code for storing the identification information and the management information related to the identification information into a storage of the first data processing apparatus, program code for performing inside-referring for referring to all the identification information and the management information stored in the storage, program code for performing outside-referring for referring to all the identification information and the management information provided by the second data processing apparatus via the communication network, and program code for producing respective referring results obtained in the inside-referring and the outside-referring together with the identification information read in the reading.

Moreover, according to the present invention, there is provided a data processing network system, comprising, a communication network used for information communication, and a plurality of data processing apparatuses each of which records and reproduces data on and from a removable medium recording identification information, and has a communication interface which communicates with another data processing apparatus via the communication network, wherein each of the data processing apparatuses comprises, a reader which reads the identification information from the removable medium when the removable medium is loaded in the data processing apparatus, a generator which generates management information for managing the data recorded on the removable medium while the data is recorded on the removable medium, a storage which stores the identification information read by the reader and the management information related to the identification information, a searcher which searches the identification information and the management information from the storage, when the identification information is read by the reader, an output device which outputs the identification information and the management information searched by the searcher, and a supplier which supplies the identification information and the management information stored in the storage to another data processing apparatus in response to a request from the another data processing apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a data recording/reproducing apparatus according to one embodiment of the present invention.

FIG. 2 is a block diagram showing a system constitution in which VTR1 to VTR3, DTV, and STB constituted as shown in FIG. 1 are connected to one another via a network in the embodiment of the present invention.

FIGS. 3A, 3B, and 3C are diagrams showing an example of information managed by each recorded program information storage section of VTR1 to VTR3 of FIG. 2.

FIG. 4 is a block diagram of a processing when a tape is loaded into any VTR in the system constitution of FIG. 2.

FIG. 5 is a flowchart showing a flow of a processing when a tape B is loaded into the VTR1 in the system constitution of FIG. 2.

FIG. 6 is a diagram showing one example of a navigation display in the processing of FIG. 5.

FIG. 7 is a block diagram of a system constitution of an embodiment to which the present invention is applied.

FIG. 8 is a flowchart showing a processing content of the VTR1 in the system constitution of FIG. 7.

FIG. 9 is a diagram showing one example of the navigation display in the embodiment of FIG. 7.

### DETAILED DESCRIPTION OF THE INVENTION

A preferred embodiment of the present invention will be described hereinafter in detail with reference to the drawings.

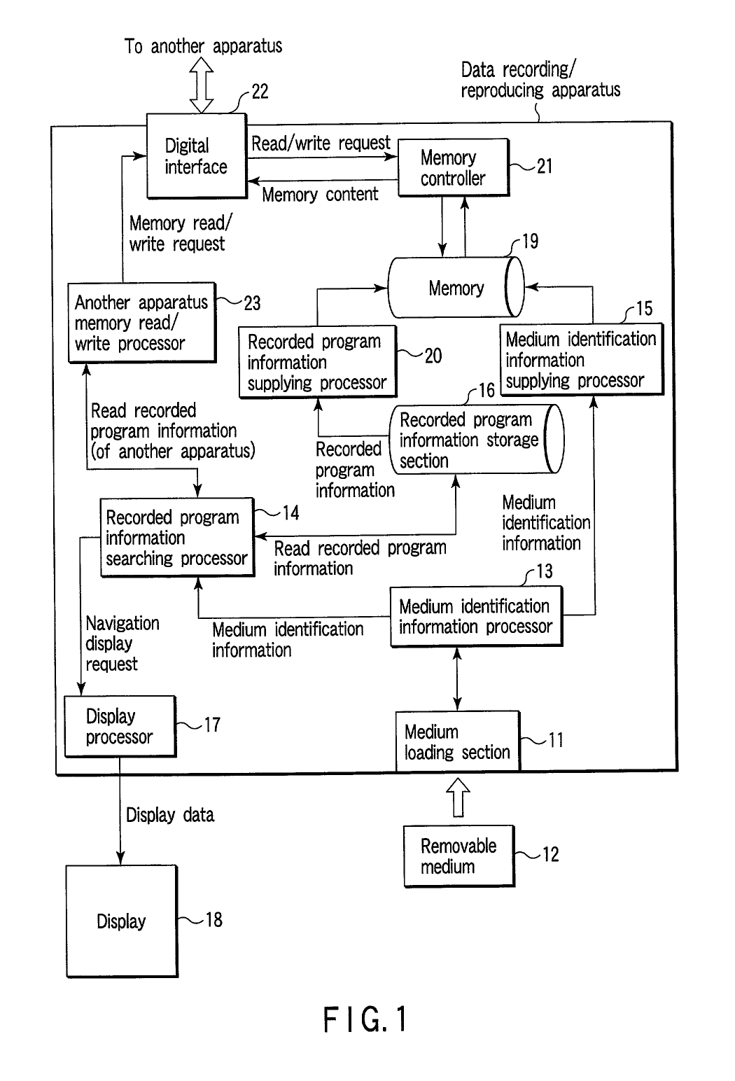

FIG. 1 shows a constitution of a data recording/reproducing apparatus according to the present invention. A removable medium 12 is selectively loaded in a medium loading section 11. When the removable medium 12 is loaded into the medium loading section 11, a medium identification information processor 13 determines whether or not identification information inherent to the medium is recorded. When the information is not recorded, the identification information inherent to the medium is recorded during recording of information on the removable medium 12. When the removable medium 12 is loaded again, the identification information inherent to the medium is read. The read identification information is sent to recorded program information searching processor 14 and medium identification information supplying processor 15.

The present apparatus includes a recorded program information storage section 16. The recorded program information storage section 16 generates recorded program information for managing program information recorded on the removable medium 12 during recording of information on the removable medium 12, and associates and stores the recorded program information with the identification information inherent to the medium.

When the medium identification information processor 13 reads the identification information of the loaded removable medium 12, the recorded program information searching processor 14 reads the recorded program information corresponding to the identification information from the recorded program information storage section 16. The recorded program information searching processor outputs a request for navigation display to a display processor 17 so that the corresponding recorded program information is displayed in a display 18.

On the other hand, on receiving the identification information from the medium identification information processor 13, the medium identification information supplying processor 15 writes the information as one piece of index information into a supplying memory 19. Accordingly, a recorded program information supplying processor 20 successively or periodically reads the recorded program information for each medium identification information stored in the recorded program information storage section 16, associates the information with the identification information obtained by the medium identification information supplying processor 15, and writes the information into the memory 19.

A memory controller 21 controls the supplying memory 19. That is, the memory controller 21 accesses the memory 19 in accordance with a read/write request, and provides the corresponding information. The present apparatus can be connected, for example, to a network of IEEE 1394 standards via a digital interface 22. When there is a read/write request from another apparatus via the digital interface 22, the memory controller 21 receives the request to read/write the corresponding information, and sends the information to a requester. Moreover, the present apparatus includes another apparatus memory read/write processor 23. The processor 23 sends a memory read/write request to another apparatus on the network, and receives a response result via the digital interface 22, when the recorded program information searching processor 14 cannot obtain the recorded program information corresponding to the medium identification information from the recorded program information storage section 16. The obtained response result is sent to the recorded program information searching processor 14, and appropriately displayed in the display 18 via the display processor 17.

A method of managing the recorded program information of the data recording/reproducing apparatus constituted as described above will be described hereinafter in terms of a concrete example. Additionally, VTR is assumed here as the data recording/reproducing apparatus, a cassette tape is assumed as the removable medium, and it is assumed that the program to be recorded can be supplied from a digital television (DTV), and set top box (STB).

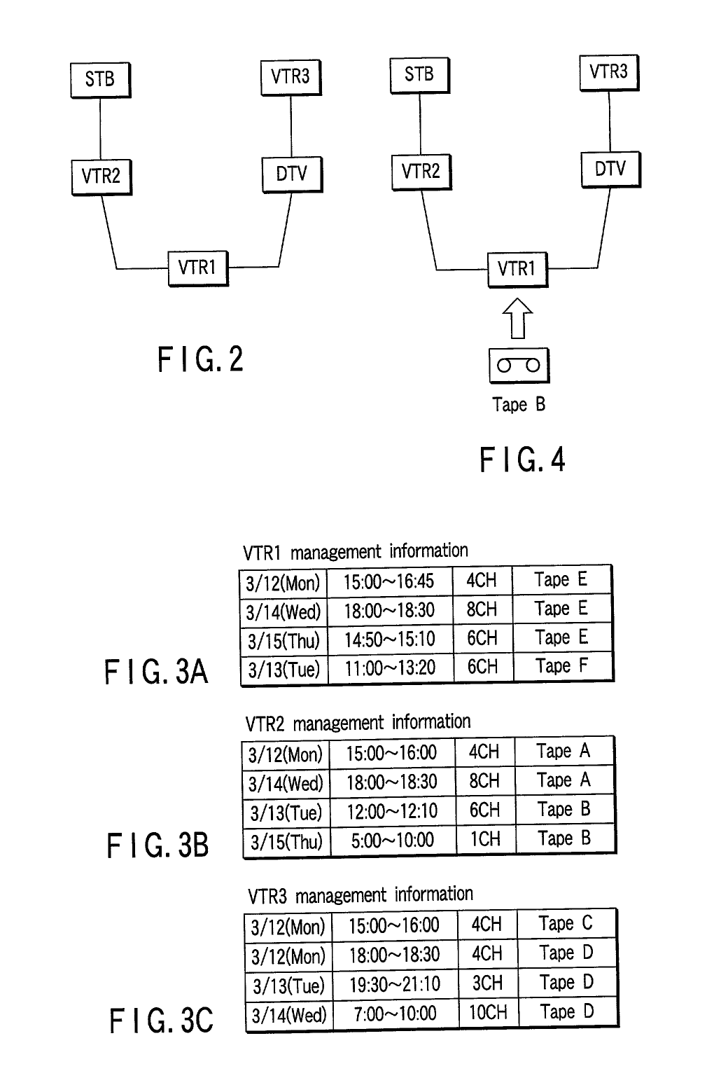

FIG. 2 shows a system constitution in which VTR1 to VTR3, DTV, and STB constituted as shown in FIG. 1 are connected to one another via a network.

Each of the VTR1 to VTR3 stores and manages the identification information of the recorded cassette tape 12 in the recorded program information storage section 16 during recording of the program on the cassette tape 12. FIGS. 3A, 3B, 3C show an example of information managed by the respective recorded program information storage sections 16 of VTR1, VTR2, and VTR3. Here, recording date and time, selected channel, tape identification information, and the like are indicated as items to be managed.

Each of the VTR1 to VTR3 manages all the tape identification information recorded in the past, and the corresponding recorded program information. Moreover, the recorded program information supplying processor 20 copies these information to the memory 19 from the recorded program information storage section 16. The information can freely be read from/written to the memory from another apparatus connected to the network. The memory is managed so that content thereof is the same as that of the recorded program information storage section 16. The memory controller 21 receives a memory read/write request from another apparatus via the digital interface 22, and returns a requested memory content to another apparatus via the digital interface 22.

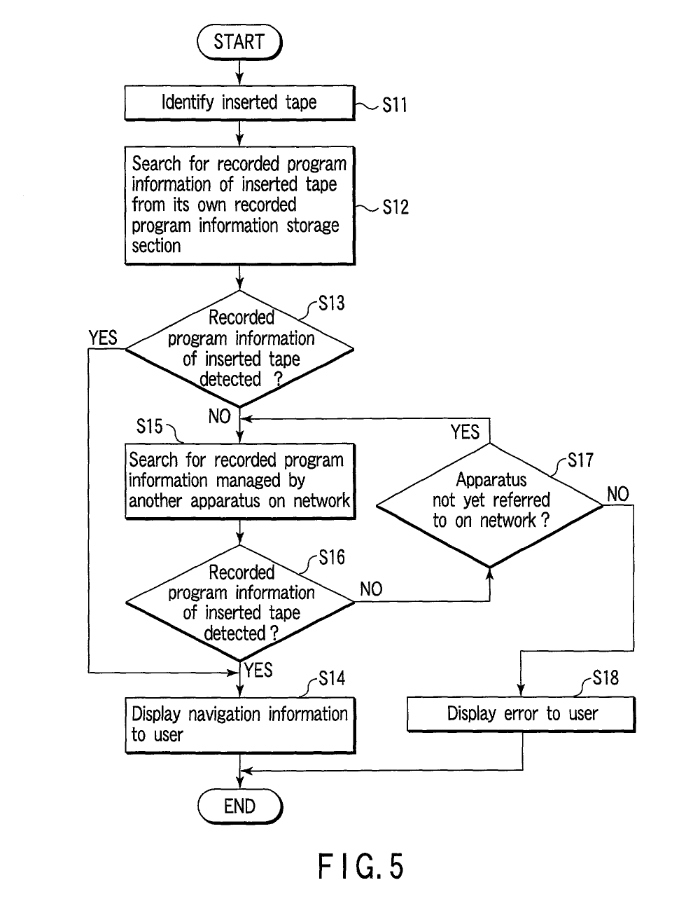

In this state, as shown in FIG. 4, it is assumed that the cassette tape having the identification information of tape B is inserted into the VTR1. Here, it is assumed that the VTR1 to VTR3 in the network manage the recorded program information shown in FIGS. 3A, 3B, and 3C. A processing content in this case will be described with reference to a flowchart of FIG. 5.

First, the medium identification information processor 13 identifies the inserted tape, and detects that the cassette tape having the identification information of tape B is inserted (step S11).

Subsequently, the recorded program information searching processor 14 searches for the recorded program information of the tape B from the recorded program information storage section 16 (step S12), and determines presence/absence of the corresponding information (step S13). In this example, as shown in FIGS. 3A, 3B, and 3C, the recorded program information storage section 16 of the VTR1 manages only the tape information having the identification information of tape E, tape F, and the desired recorded program information of the tape B cannot be detected in this stage. If there is the recorded program information for the inserted tape B, a navigation display request is sent to the display processor 18, and navigation information of the tape B is outputted to the display 18 (step S14).

When the information belonging to the tape B inserted in the search processing of the step S12 cannot be detected, the recorded program information searching processor 14 reads the recorded program information managed by another apparatus in order via the another apparatus memory read/write processor 23 (step S15), and detects whether or not there is desired information (step S16). In this example, since the information cannot be detected in the search processing of the step S12, memory content is next read from the memory 19 of VTR2. As shown in FIGS. 3A, 3B, 3C, VTR2 manages the recorded program information corresponding to the tapes A and B recorded in the past, and the information on the tape B inserted into the VTR1 can be referred to.

When the desired information cannot be detected in the search processing of the step S15, the memory content of another VTR is read, and subsequently the recorded program information continues to be searched (step S17).

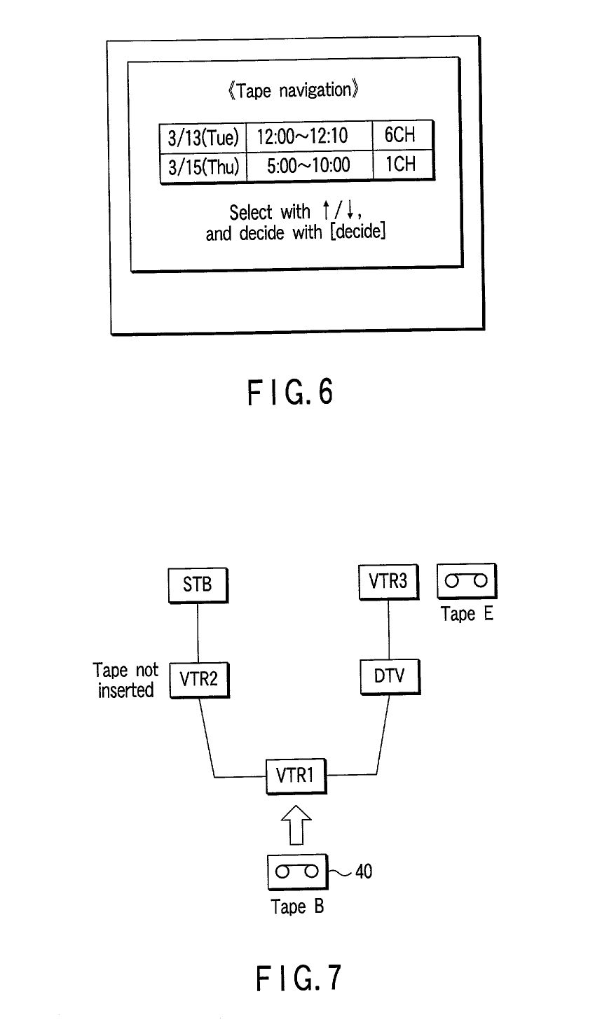

When the desired recorded program information is successfully searched in the step S16, the navigation information is displayed in the display 18 via the display processor 17 (step S14). Additionally, the navigation information may be displayed in its own display (front panel), or in an analog-connected display (analog television, and the like), or displayed in a digital television set via the digital interface. One example of a navigation display is shown in FIG. 6.

When the desired information cannot be detected even by searching the information supplied by all the apparatuses on the network through the processing (steps S15 to S17), a navigation function cannot be realized. In this case, similarly as the step S14, the display is controlled, so that an error, for example, “the navigation information of the inserted tape does not exist” is displayed to the user (step S18).

Through the processing executed as described above, even when the VTR other than the VTR having recorded the information into the tape reproduces the content of the tape, and when the VTR having recorded the information into the inserted tape is connected to the network, the recorded program information of the tape can be subjected to the navigation display. In this example, the VTR2 has recorded the information into the tape B, but the information of the tape B is reproduced by the VTR1. Even in this case, the navigation function can be realized.

An embodiment to which the present invention is applied will next be described with reference to the drawings.

First, as shown in FIG. 7, a system constitution is assumed in which a digital television (DTV), set top box (STB) and three videos (VTR1 to VTR3) are connected to one another via the network. Similarly as the aforementioned embodiment, each of the VTR1 to VTR3 manages all the tape identification information recorded in the past, and the corresponding recorded program information. Moreover, the cassette tape having the identification information of tape B is inserted into VTR1, the cassette tape having the identification information of tape E is inserted into VTR3, and no cassette tape is inserted into the VTR2. Similarly as the recorded program information, the identification information of the presently inserted cassette tape is copied to the memory 19 which the information can freely be read from/written to by another apparatus connected to the network, and managed by the medium identification information supplying processor 15. The memory controller 21 receives the memory read/write request from another apparatus via the digital interface 22, and returns the requested memory content to another apparatus via the digital interface 22. In this constitution, the tape inserted into the specified VTR can be identified from the other apparatuses on the network.

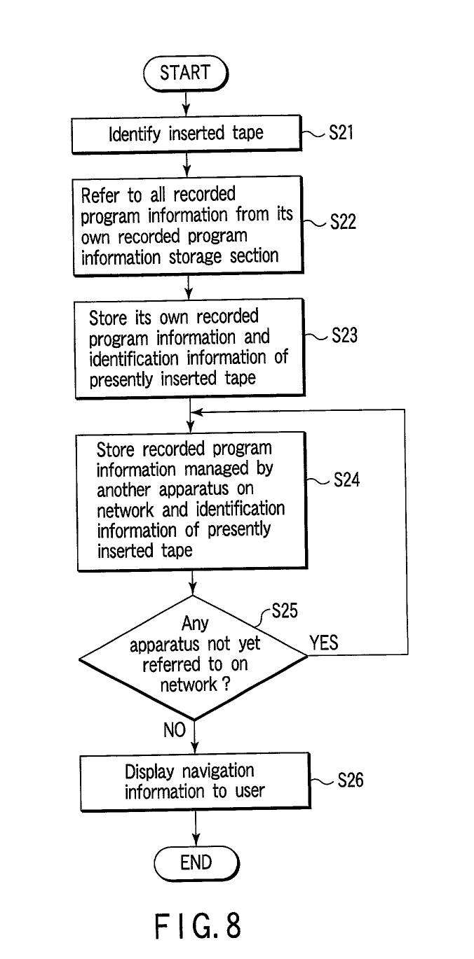

A processing content in this case will be described with reference to a processing flowchart of FIG. 8.

First, the medium identification information processor 13 identifies the inserted tape, and detects that the cassette tape having the identification information of tape B is inserted (step S21).

Subsequently, the recorded program information searching processor 14 searches all the recorded program information managed by the recorded program information storage section 16 (step S22), and stores the identification information (tape B) of the presently inserted tape and all the recorded program information managed by itself, which have been obtained by the steps S21 and S22 (step S23).

Also with respect to another apparatus on the network, the recorded program information managed by another apparatus and the identification information of the presently inserted tape are read and stored in order via another apparatus memory read/write processor 23 (step S24). When the processing of the step S24 is performed for all the apparatuses on the network, the recorded program information of all the data recording/reproducing apparatuses connected to the network and the identification information of the presently inserted tape are obtained (step S25).

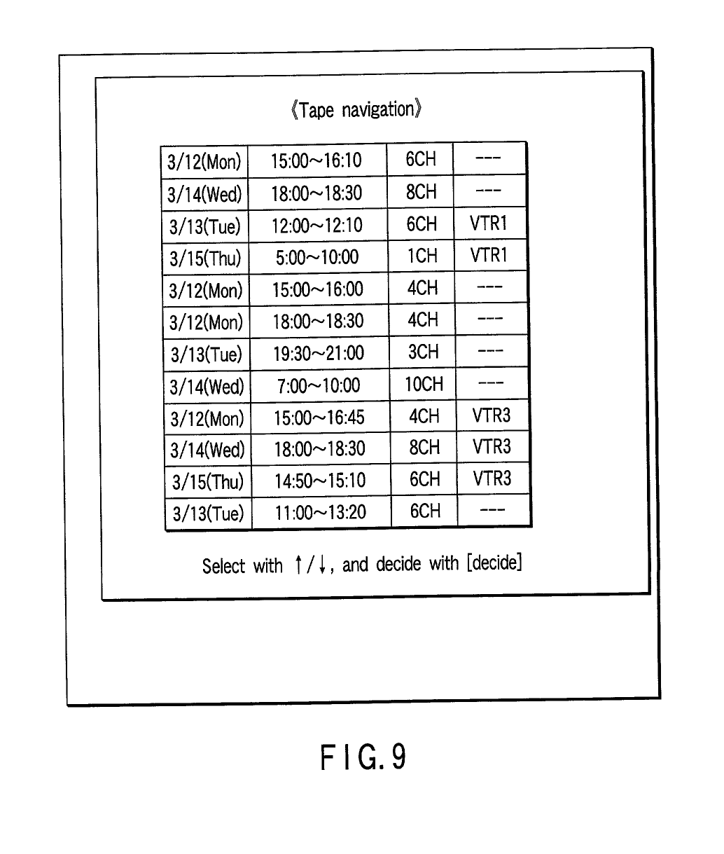

The navigation information is displayed in the display 18 via the display processor 17 based on the information obtained by the processing up to the step S24. Similarly as the aforementioned embodiment, the navigation information may be displayed in its own display (front panel), or in the analog-connected display (analog television, and the like), or displayed in the digital television set via the digital interface. One example of the navigation display is shown in FIG. 9.

In this display example, a list of the recorded program information possessed by all the VTRs connected to the network is displayed, and it is also displayed whether the tape corresponding to the recorded program information is now inserted in any VTR connected to the network. That is, it can be confirmed according to the obtained information that the tapes B and E are now inserted into VTR1 and VTR3, respectively. Therefore, the information of the VTR into which each tape is now inserted is also displayed on the right side of the recorded program information of the tapes B and E.

Moreover, a digital interface for supporting a control command by which the apparatus can be controlled via the network may be mounted. In this example, the apparatus can be controlled via a navigation screen. This example will be described. When the program recorded in the tape B or E is selected from a menu by the user, the control command indicating tape reproduction is transmitted to the VTR1 or VTR3, a reception processing of an image/sound is also performed, and the program selected by the user is reproduced by the VTR1 or VTR3 and can be displayed in DTV.

When the tape with the desired program recorded therein is inserted into any VTR connected to the network, the user can reproduce and watch the desired program without noticing the VTR with the tape including the recorded program inserted therein.

Additionally, in the aforementioned embodiment, the VTR1 to VTR3 share/manage the tape identification information and recorded program information. However, DTV may have such function, collect the information from the respective VTR1 to VTR3, and perform the navigation display on the display screen, for example, as shown in FIG. 9.

As the medium identification information, a manufacturer number, manufacturing number, recording date and time, and the like may be combined and constituted so that the same information is prevented from being issued among the apparatuses on the network.

Moreover, when the data processing apparatuses on the network share the information, a form needs to be standardized. However, even if the form is not necessarily completely standardized, a degree of freedom in handling the information can be imparted to the respective apparatuses by disposing a form converting function, for example, in the supplying processors 15, 20.

Additionally, the present invention is not limited to the aforementioned embodiments, and can variously be modified and carried out.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A data processing apparatus which records and reproduces data on and from a removable medium recoding identification information, and has a communication interface communicating with another data processing apparatus via a communication network, the data processing apparatus comprising:
a reader which reads the identification information from the removable medium when the removable medium is loaded in the data processing apparatus;
a generator which generates management information for managing the data recorded on the removable medium while the data is recorded on the removable medium;
a storage which stores the identification information read by the reader and the management information related to the identification information;
a searcher which searches the identification information and the management information from said storage, when the identification information is read by said reader;
an output device which outputs the identification information and the management information searched by said searcher; and
a supplier which supplies the identification information and the management information stored in said storage to another data processing apparatus in response to a request from the another data processing apparatus.

2. The data processing apparatus according to claim 1, further comprising;
a determination device which determines whether or not the identification information is recorded on the removable medium when the removable medium is loaded in the data processing apparatus, and
a recorder which records the identification information on the medium while the data is recorded on the removable medium when the determining means determines that the identification information is not recorded on the medium.

3. The data processing apparatus according to claim 1, wherein said searcher requests for management information together with identification information designated therein to the another data processing apparatus on the communication network via the communication interface, receives the management information with a response from the another data processing apparatus, and outputs a search result, when the management information corresponding to the identification information is not obtained from said storage.

4. The data processing apparatus according to claim 1, further comprising;
a collector which periodically collects the identification information and the management information provided by the another data processing apparatus on the communication network,
said searcher searching for the desired information from a collection result of said collector, when the management information corresponding to the identification information is not obtained from said storage.

5. The data processing apparatus according to claim 1, wherein said supplier comprises a form converter which converts the information into a predetermined form to share the information with the another data processing apparatus on the communication network.

6. A data processing apparatus having a communication interface, which communicates with another data processing apparatus via a communication network,
wherein the another data processing apparatus reads inherent identification information from a removable medium when the removable medium is loaded in the another data processing apparatus, and generates management information for managing data recorded on the removable medium while the data is recorded on the removable medium, and said data processing apparatus comprises:
a collector which collects the identification information and the management information provided by the another data processing apparatus on the communication network via the communication interface; and
an output device which outputs the information collected by the collector.

7. The data processing apparatus according to claim 6, wherein said collector collects, through the communication network, identification information identifying another data processing apparatus in which the removable medium is presently loaded, and also collects the identification information and management information regarding the removable medium, and said output device has a function for identifying which data processing apparatus contains the removable medium to output information indicating an identified data processing apparatus.

8. The data processing apparatus according to claim 7, further comprising:
a controller which controls the data processing apparatus identified by said output device to reproduce the removable medium loaded therein.

9. A data processing apparatus which records and reproduces data on and from a removable medium recording identification information, and has a communication interface communicating with another data processing apparatus via a communication network, said data processing apparatus comprising:
reading means for reading the identification information when the removable medium is loaded in said data processing apparatus;
generating means for generating management information for managing the data recorded on the removable medium while the data is recorded on the removable medium;
a storing means for storing the identification information and the management information related to the identification information;
searching means for searching the identification information and the management information from said storing means, when the identification information is read by said reading means;
producing means for producing the identification information and the management information searched by said searching means; and
providing means for providing the identification information and the management information stored in said storing means to another data processing apparatus in response to a request from the another data processing apparatus.

10. The data processing apparatus according to claim 9, further comprising;
determining means for determining whether or not identification information is recorded in the removable medium when the removable medium is loaded in the data processing apparatus, and
recording means for recording the identification information on the removable medium when the determining means determines that the identification information is not recorded.

11. The data processing apparatus according to claim 9, wherein said searching means requests for management information together with identification information designated therein to the another data processing apparatus on the communication network via the communication interface, receives the management information with a response from the another data processing apparatus, and outputs a search result, when the management information corresponding to the identification information is not obtained from said storing means.

12. The data processing apparatus according to claim 9, further comprising;
collecting means for periodically collecting the identification information and the management information provided by the another data processing apparatus on said communication network,
said searching means searching for the identification information from a collection result of said collecting means, when the management information corresponding to the identification information is not obtained from said storing means.

13. The data processing apparatus according to claim 9, wherein said providing means comprises converting means for converting the information into a predetermined form to share the information with the another data processing apparatus on said communication network.

14. A data processing apparatus having a communication interface communicating with another data processing apparatus via a communication network,
wherein the another data processing apparatus reads inherent identification information from a removable medium when the removable medium is loaded in the another data processing apparatus, and generates management information for managing data recorded on the removable medium while the data is recorded on the removable medium, and said data processing apparatus comprises:
collecting means for collecting the identification information and the management information provided by the another data processing apparatus on the communication network via the communication interface; and
output means for outputting the information collected by said collecting means.

15. The data processing apparatus according to claim 14, wherein said collecting means collects, through the communication network, identification information identifying a data processing apparatus in which the removable medium is presently set, and also collects the identification information and management information regarding the removable medium, and said output means has a function for identifying which data processing apparatus contains the removable medium and to output information identifying an identified data processing apparatus.

16. The data processing apparatus according to claim 15, further comprising:
controlling means for controlling the data processing apparatus identified by said output means to reproduce the removable medium loaded therein.

17. An information managing method for a first data processing apparatus which records and reproduces data on and from a removable medium recording identification information and communicates with at least one second data processing apparatus via a communication network, said method comprising:
reading the identification information from the removable medium when the removable medium is loaded in the first data processing apparatus;
generating management information for managing the data recorded on the removable medium while the data is recorded on the removable medium;
storing the identification information and the management information related to the identification information into a storage of the first data processing apparatus;
performing inside-searching for searching said storage of the first data processing apparatus for the identification information and the management information, when the identification information is read from the removable medium;
performing outside-searching for searching the second data processing apparatus for the identification information and the management information, when the identification information and the management information are not detected from said storage; and
outputting the identification information and the management information detected in said inside-searching and said outside-searching.

18. An information managing method for a first data processing apparatus which records and reproduces data on and from a removable medium recoding identification information and communicates at least one second data processing apparatus via a communication network, said method comprising:
reading the identification information when the removable medium is loaded in the first data processing apparatus;
generating management information for managing the data recorded in the removable medium while the data is recorded on the removable medium;
storing the identification information and the management information related to the identification information into a storage of the first data processing apparatus;
performing inside-referring for referring to all the identification information and the management information stored in said storage;
performing outside-referring for referring to all the identification information and the management information provided by the second data processing apparatus on the communication network; and
outputting respective referring results obtained in said inside-referring and said outside-referring together with the identification information read by said reading.

19. A computer program product for operating a computer for managing information of a first data processing apparatus which records and reproduces data on and from a removable medium recording identification information and communicates at least one second data processing apparatus via a communication network, the computer program product comprising:
program code for reading the identification information from the removable medium when the removable medium is loaded in the first data processing apparatus;
program code for generating management information for managing the data recorded on the removable medium while the data is recorded on the removable medium;
program code for storing the identification information and the management information related to the identification information into a storage of the first data processing apparatus;
program code for performing inside-searching for searching the storage of the first data processing apparatus for the identification information and the management information, when the identification information is read in said reading;
program code for performing outside-searching for searching the second data processing apparatus for the identification information and the management information, when the identification information and the management information are not detected in the inside-searching; and
program code for outputting the identification information and the management information detected in said inside searching and said outside searching.

20. A computer program product for operating a computer for managing information of a first data processing apparatus which records and reproduces data on and from a removable medium recording identification information and communicates at least one data processing apparatus via a communication network, the computer program product comprising:
program code for reading the identification information from the removable medium when the removable medium is loaded in the first data processing apparatus;
program code for generating management information for managing the data recorded on the removable medium while the data is recorded on the removable medium;
program code for storing the identification information and the management information related to the identification information into a storage of the first data processing apparatus;
program code for performing inside-referring for referring to all the identification information and the management information stored in the storage;
program code for performing outside-referring for referring to all the identification information and the management information provided by the second data processing apparatus via the communication network; and
program code for producing respective referring results obtained in said inside-referring and said outside-referring together with the identification information read in said reading.

21. A data processing network system, comprising:
a communication network used for information communication; and
a plurality of data processing apparatuses each of which records and reproduces data on and from a removable medium recording identification information, and has a communication interface which communicates with another data processing apparatus via the communication network,
wherein each of said data processing apparatuses comprises:
a reader which reads the identification information from the removable medium when the removable medium is loaded in the data processing apparatus;
a generator which generates management information for managing the data recorded on the removable medium while the data is recorded on the removable medium;
a storage which stores the identification information read by the reader and the management information related to the identification information;
a searcher which searches the identification information and the management information from said storage, when the identification information is read by said reader;
an output device which outputs the identification information and the management information searched by said searcher; and
a supplier which supplies the identification information and the management information stored in said storage to another data processing apparatus in response to a request from the another data processing apparatus.
